(19) United States
(12) Patent Application Publication
(10) Pub. No.: US 2024/0037466 A1
(43) Pub. Date: Feb. 1, 2024

(54) PLANT OPERATION ASSISTANCE SYSTEM

(71) Applicant: Mitsubishi Electric Corporation, Chiyoda-ku, Tokyo (JP)

(72) Inventors: Mami NARUSE, Chiyoda-ku, Tokyo (JP); Nami YAMAMOTO, Chiyoda-ku, Tokyo (JP); Mitsunobu YOSHINAGA, Chiyoda-ku, Tokyo (JP)

(73) Assignee: Mitsubishi Electric Corporation, Chiyoda-ku, Tokyo (JP)

(21) Appl. No.: 18/258,364

(22) PCT Filed: Feb. 26, 2021
(86) PCT No.: PCT/JP2021/007267

§ 371 Date: Jun. 20, 2023

(51) Int. Cl. G06Q 10/0631

(52) U.S. Cl. CPC G06Q 10/063112; G06Q 10/063114

(57) ABSTRACT

The plant operation assistance system includes a plant information acquisition unit for acquiring plant information, an operator information acquisition unit for acquiring operator information, a work information acquisition unit for acquiring work information, a plant status identification unit for identifying a plant status from the plant information, a handling priority determination unit for determining handling priority for a plurality of units, a scheduling unit for creating schedule candidates from the handling priority, an operator state identification unit for identifying the status of an operator from the operator information and the work information, a schedule evaluation unit for evaluating the schedule candidates from the state of the operator, and a schedule presentation unit for presenting a schedule in accordance with the schedule evaluation result.

### TECHNICAL FIELD

This application relates to a plant operation assistance system.

### BACKGROUND ART

In recent years, a software type digital monitoring and control panel (digital panel) has been introduced in place of a conventional hardware type analog monitoring and control panel in the monitoring and control system for a large-scale plant in an electric power field or the like. In the digital panel, work is performed using a graphical user interface (GUI) in which monitoring and control functions are integrated, making it possible to reduce the size of equipment and a load on an operator in the operation.

In the plant operation, work procedures for events and an operator in charge of executing individual operation is determined in advance. However, due to increasing functionality of a monitoring and control system and resulting reduction in the number of operators, it is expected that a plurality of units are monitored simultaneously with a minimum number of operators during the normal operation and that the number of operators or a system will be changed when an event occurs. Predetermined work assignment may not be able to respond in time when an unexpected combination of events occurs, which may lead to a severe accident, and thus dynamic work assignment is in demand.

In the plant operation, each operator has a display device to operate and monitor plant equipment of his/her responsibility, and the display device displays the operation and monitoring status of the plant equipment of his/her responsibility, as well as the operation and monitoring status of plant equipment for which the other operators are responsible in accordance with the order of execution by each operator (refer to, for example, Patent Document 1).

Further, in the plant operation, processes that are performed includes an operator skill update process that updates skill performance values of a work skill table by counting the number of times each operator has performed work, etc., from work history information, a work registration process that registers work master information in a work master table, an operator assignment process in which the required number of operators for each of work levels is obtained using a work classification ID as a key, the required number of operators for a work level matching the priority of an extracted work level is extracted from an operator skill table, and the most suitable operator for individual work is extracted by searching for an operator who matches a skill level stored in the work skill table from the extracted operators excluding those who do not match conditions such as the work performance stored in the work skill table, and a work performance registration process that updates work assignment information in the work master table (refer to, for example, Patent Document 2).

### CITATION LIST

### Patent Document

Patent Document 1: Japanese Patent Application Publication Laid-open, No. 2012-103883
Patent Document 2: Japanese Patent Application Publication Laid-open, No. 2014-191390

### SUMMARY OF INVENTION

### Problems to be Solved by Invention

Conventional technology supports the operation by displaying predetermined work assignments for operators according to their roles or their areas of responsibility, but problems arises in that it does not implement dynamic work assignments for each operator in consideration of the detailed situation of the plant or operators, or an impact on the entire plant (hereinafter referred to as a plant integrated unit), such as risk, a handling time, and costs under simultaneous operation of a plurality of units to be assumed. A problem also arises in that no consideration is given how to deal with a shortage of operators under an existing condition at the time when an event occurs.

An object of the present application is to solve the above problems and to provide a system that can reduce the risk, improve work efficiency, and reduce costs by setting details of parameters (risk, handling time, etc.) that affect the entire plant at the time of an event on the basis of the detailed situation for each plant and for each operator, presenting a schedule for each operator in accordance with the details of the parameters, and identifying and supplementing the most suitable operator when there is a shortage of operators.

### Means for Solving Problems

A plant operation assistance system disclosed in the present application includes a plant information acquisition unit to acquire information on a plant including an impact degree of an event, an event probability, a handling time for the event, and variable information including an operation history of the plant, an operator information acquisition unit to acquire operator information including information on an owned qualification, a proficiency level, and a work status for operators of the plant, a work information acquisition unit to acquire work information of the plant including work contents, a work procedure, and a work difficulty level, a plant status identification unit to identify an event occurring at the plant from information acquired by the plant information acquisition unit, a handling priority determination unit to determine, for a plurality of plants, handling priority for determining an operation procedure for each plant when an event occurs, a scheduling unit to schedule a work procedure for each plant on the basis of the determined handling priority for the plants and to output a plurality of work procedure schedules, an operator state identification unit to identify an operator state including a work status and a physical state for each operator from the operator information and the work information, a schedule evaluation unit to set a plurality of parameters affecting operation of a plant integrated unit integrating the plurality of plants on the basis of the operator state outputted by the operator state identification unit, to calculate an impact on the operation of the plant integrated unit using the plurality of parameters, and to evaluate the work procedure schedules outputted by the scheduling unit on the basis of the impact, and a schedule presentation unit to present an evaluation result of the schedules evaluated by the schedule evaluation unit to an output device.

### Effect of Invention

The plant operation assistance system disclosed according to the present application can provide a system that can reduce the risk, improve work efficiency, and reduce costs in the plant operation by setting details of parameters (risk, handling time, etc.) that affect the entire plant at the time of an event on the basis of the detailed situation for each plant and for each operator, presenting a schedule for each operator in accordance with the details of the parameters, and identifying and supplementing the most suitable operator when there is a shortage of operators.

### BRIEF DESCRIPTION OF DRAWINGS

FIG. 1 is a hardware configuration diagram of a computer of a plant operation assistance system according to Embodiment 1.

FIG. 2 is a functional block diagram of the plant operation assistance system according to Embodiment 1.

FIG. 3 is a flowchart of the plant operation assistance system according to Embodiment 1.

FIG. 4 shows an example of plant information of the plant operation assistance system according to Embodiment 1.

FIG. 5 shows an example of operator information of the plant operation assistance system according to Embodiment 1.

FIG. 6 shows an example of work information of the plant operation assistance system according to Embodiment 1.

FIG. 7 shows an example of a plant status of the plant operation assistance system according to Embodiment 1.

FIG. 8 shows an example of a relationship between a risk value and risk in the plant operation assistance system according to Embodiment 1.

FIG. 9 shows an example of a relationship between a margin time and a margin in the plant operation assistance system according to Embodiment 1.

FIG. 10 shows a relationship between the risk, the margin, and urgency in the plant operation assistance system according to Embodiment 1.

FIG. 11 shows an example of a schedule result of the plant operation assistance system according to Embodiment 1.

FIG. 12 shows an example of an operator state of the plant operation assistance system according to Embodiment 1.

FIG. 13 shows an example of an impact of the risk depending on the operator state in the plant operation assistance system according to Embodiment 1.

FIG. 14 shows an example of schedule presentation in the plant operation assistance system according to Embodiment 1.

FIG. 15 shows an example of an addition necessity determination rule in the plant operation assistance system according to Embodiment 1.

FIG. 16 is a functional block diagram of a plant operation assistance system according to Embodiment 2.

FIG. 17 shows an example of an evaluation determination rule in the plant operation assistance system according to Embodiment 2.

FIG. 18 shows an example of schedule presentation of the plant operation assistance system according to Embodiment 2.

FIG. 19 shows an example of a notification of a schedule result of the plant operation assistance system according to Embodiment 2.

### MODES FOR CARRYING OUT INVENTION

### Embodiment 1

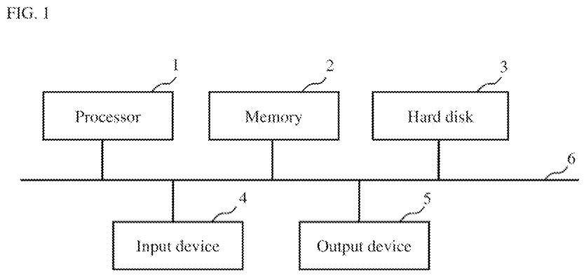

A plant operation assistance system according to Embodiment 1 will be described below on the basis of drawings. FIG. 1 shows a hardware configuration of a plant operation assistance system. The system includes a processor 1, a memory 2, a hard disk 3, an input device 4, an output device 5, and a system bus 6 connecting them.

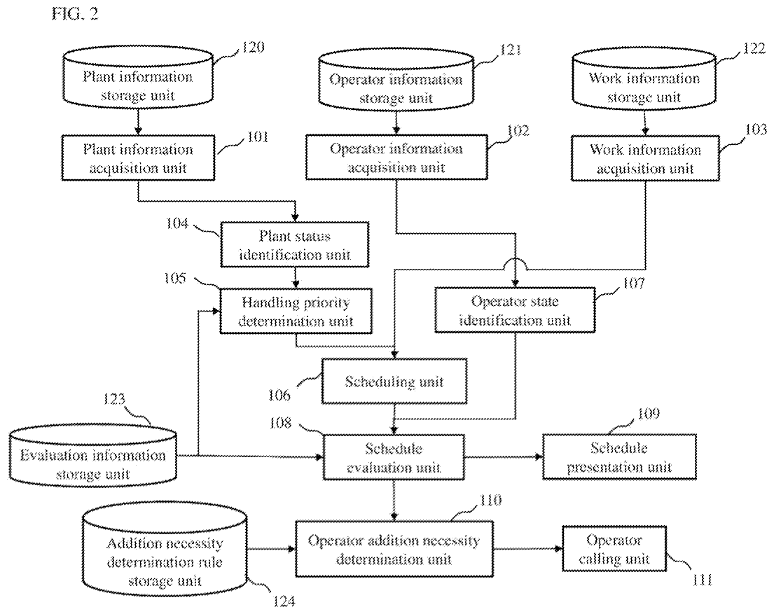

FIG. 2 is a functional block diagram for explaining the plant operation assistance system according to Embodiment 1. As shown in FIG. 2, the plant operation assistance system is provided with several components to be described below.

That is, the plant operation assistance system includes a plant information acquisition unit 101 for acquiring plant information, an operator information acquisition unit 102 for acquiring operator information, a work information acquisition unit 103 for acquiring work information, a plant status identification unit 104 for identifying a plant status from the plant information, a handling priority determination unit 105 for determining handling priority in a plurality of units, a scheduling unit 106 for creating candidates of schedules from the determined handling priority for the units, an operator state identification unit 107 for identifying an operator state from the operator information and the work information, a schedule evaluation unit 108 for evaluating the candidates of the schedules from the identified operator state, a schedule presentation unit 109 for presenting schedules according to the evaluation result of the evaluated schedules, and an operator addition necessity determination unit 110 for determining necessity of operator addition according to an addition necessity determination rule for operators stored in an addition necessity determination rule storage unit in which a determination rule for the necessity of operator addition is stored, and an operator calling unit 111 for calling a necessary operator according to an output of the operator addition necessity determination unit.

The above components, which are the plant information acquisition unit 101, the operator information acquisition unit 102, the work information acquisition unit 103, the plant status identification unit 104, the handling priority determination unit 105, the scheduling unit 106, the operator state identification unit 107, the schedule evaluation unit 108, the schedule presentation unit 109, the operator addition necessity determination unit 110, and the operator calling unit 111, are each operated by the processor 1 shown in FIG. 1, the processor executing a program stored in the memory 2 or the hard disk 3 to perform respective functions.

In the example shown in FIG. 2, the processor 1, the memory 2, and the hard disk 3 are each composed of a single unit, but this is not a limitation. The above functions may be implemented in cooperation with multiple processors 1, multiple memories 2, and multiple hard disks 3.

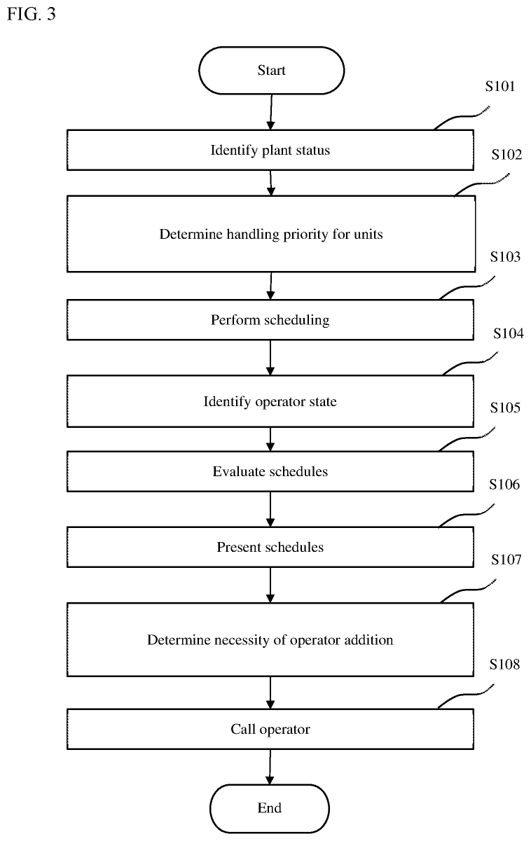

FIG. 3 is a flowchart showing operation of the plant operation assistance system according to Embodiment 1. Using FIG. 3 to FIG. 15, the operation will be described in which the plant operation assistance system identifies the plant status and the operator state on the basis of the plant information, the operator information, and the work information, dynamically assigns a handling procedure of the most suitable operator in accordance with the plant status and the operator state that are identified, determines the necessity of operator addition, and then outputs a schedule result to an external output device such as a monitor or a speaker and calls an additional operator.

In the present embodiment, Plant 1 to Plant 4 in a plurality of plants are taken as a target, and an example of a case in which a plurality of operators perform the operation will be described. Thereafter, Plant 1 may be referred to as UNIT 1, Plant 2 as UNIT 2, Plant 3 as UNIT 3, and Plant 4 as UNIT 4.

The plant information acquisition unit 101 acquires plant information stored in a plant information storage unit 120. The plant information stored in the plant information storage unit includes static information such as event information (specific examples will be described later) and dynamic information such as plant parameters or an operation history, which is acquired by individual plant equipment. The plant parameters include operating conditions including alarms for various plant equipment, or process values. Here, the plant equipment is equipment that constitutes a plant. It includes, for example, motors, pumps, valves, etc., which varies depending on a type of the plant. Typically, the plant information is usually prepared for each plant.

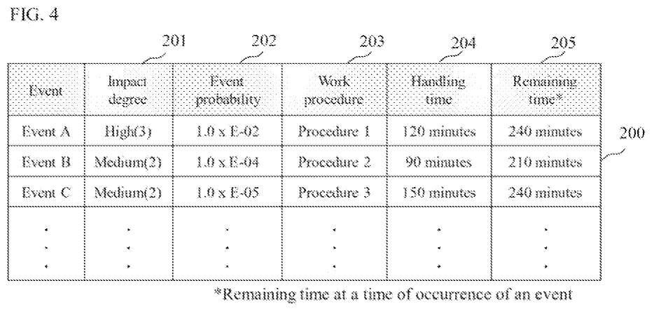

FIG. 4 is an example of the event information, which is a piece of the plant information to be acquired by the plant information acquisition unit according to the present embodiment. The event information 200 includes an impact degree 201, an event probability 202, a work procedure 203, a handling time 204, and a remaining time 205 (remaining time at the time of occurrence of an event) for each event.

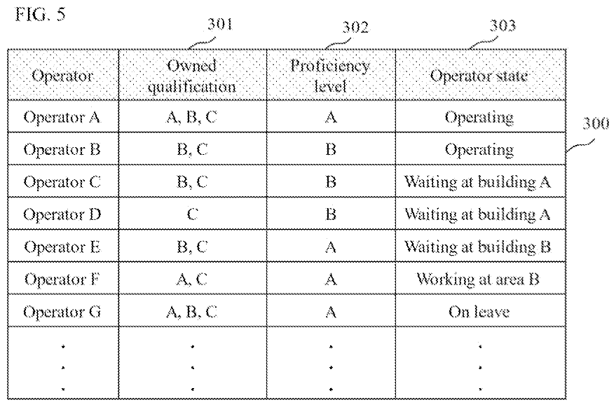

Next, the operator information acquisition unit 102 acquires the operator information stored in the operator information storage unit 121. The operator information stored in the operator information storage unit 121 includes static information such as an operator's qualification or personality and dynamic information such as the operator state or biometric information of an operator. FIG. 5 shows an example of the operator information acquired by the operator information acquisition unit according to the present embodiment. The operator information 300 includes an owned qualification 301, which is qualification information held by each operator, and a proficiency level 302 for each operator, and a work status 303, which represents each operator's work status, such as whether the operator is operating or waiting.

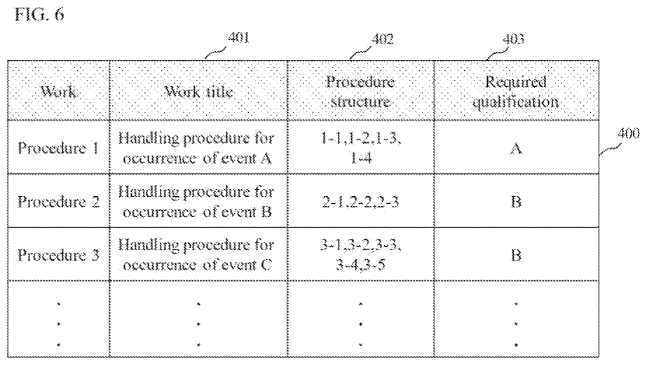

Next, the work information acquisition unit 103 acquires the work information stored in the work information storage unit 122. The work information stored in the work information storage unit 122 includes details of the work procedures or difficulty of the work. FIG. 6 shows an example of the work information acquired by the work information acquisition unit according to the present embodiment. The work information 400 includes a work title 401 for individual work, a procedure structure 402, and a required qualification 403.

The plant status identification unit 104 identifies the plant status of each plant from the plant information acquired by the plant information acquisition unit 101 (refer to step S101 in FIG. 3). In the present embodiment, an occurring event within the plants is identified from the above-described plant parameters such as alarm information, and procedures in operation are identified from the operation history of the plants.

Identifying the occurring event is done using knowledge-based information that stores data needed to identify an event, the data being such as a relationship between a factor that causes the event, and a spillover effect of the event.

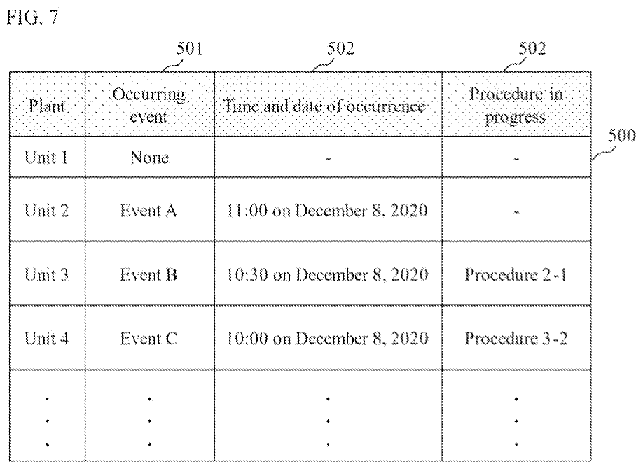

FIG. 7 shows an example of a plant status identified by the plant status identification unit 104 according to the present embodiment. The plant status 500 includes an occurring event 501, a time and date of occurrence 502, and a procedure-in-progress 503, for each plant.

In the present embodiment, with a situation in which Event B has occurred at Plant 3 and Event C has occurred at Plant 4, an example in which Event A occurs at Plant 2 at 11:00 on Dec. 8, 2020 will be specifically described below. Note that, at present, two operators, Operator A and Operator B, are operating in handling the events.

Then, the handling priority determination unit 105 determines the handling priority of each plant in consideration of the contents or progress status of the event (refer to step S102 in FIG. 3). In the present embodiment, on the basis of the evaluation information stored in the evaluation information storage unit 123, the handling priority is determined by urgency in consideration of risk of an event occurring in each plant and the margin time for the handling work. The evaluation information storage unit 123 stores information to be used for the handling priority determination unit 105 to determine the handling priority of each plant or information to be used for the evaluation by the schedule evaluation unit 108.

First, the risk of an event will be described. The risk of an event can be calculated as the product of an impact degree of the event and an event probability. When the risk is calculated from the plant information in FIG. 4, it is 3.0×E-2 (E-2 means 10 raised to the power of −2 for Event A in Plant 2. In this case, the impact degree is 3 and the event probability is 1/100, and the remaining is calculated in the same way), it is 2.0×E-4 for Event B in Plant 3, and it is 2.0×E-5 for Event C in Plant 4.

Next, the margin time will be described. The margin time for a current handling work can be calculated as the difference between a remaining time for handling the event and the handling time. In the present embodiment, an implementation time required for each procedure (e.g., Procedure 1-1) of the work procedures is uniformly set at 30 minutes. On the basis of the calculation from the event information 200 in FIG. 4 and the plant status 500 in FIG. 7, for Event A in Plant 2, four procedures of 120 minutes from Procedure 1-1 to Procedure 1-4 remain as of 11:00 on Dec. 8, 2020 and the remaining time is 240 minutes on the occurrence at 11:00 on Dec. 8, 2020, leaving 120 minutes as the margin time resulting from 240 minutes minus 120 minutes. Similarly, for Event B in Plant 3, two procedures of 60 minutes from Procedure 2-2 to Procedure 2-3 remain as of 11:00 on Dec. 8, 2020 and the remaining time is 180 minutes (=210 (the remaining time at the time of occurrence)−30 (the elapsed time)) on the occurrence at 10:30 on Dec. 8, 2020, leaving 120 minutes as the margin time resulting from 180 minutes minus 60 minutes. Similarly, for Event C in Plant 4, three procedures of 90 minutes from Procedure 3-3 to Procedure 3-5 remain as of 11:00 on Dec. 8, 2020 and the remaining time is 180 minutes (=240 (the time remaining at the time of occurrence)−60 (the elapsed time)) on the occurrence at 10:00 on Dec. 8, 2020, leaving 90 minutes as the margin time resulting from 180 minutes minus 90 minutes (refer to FIG. 4 for the remaining time at the time of occurrence).

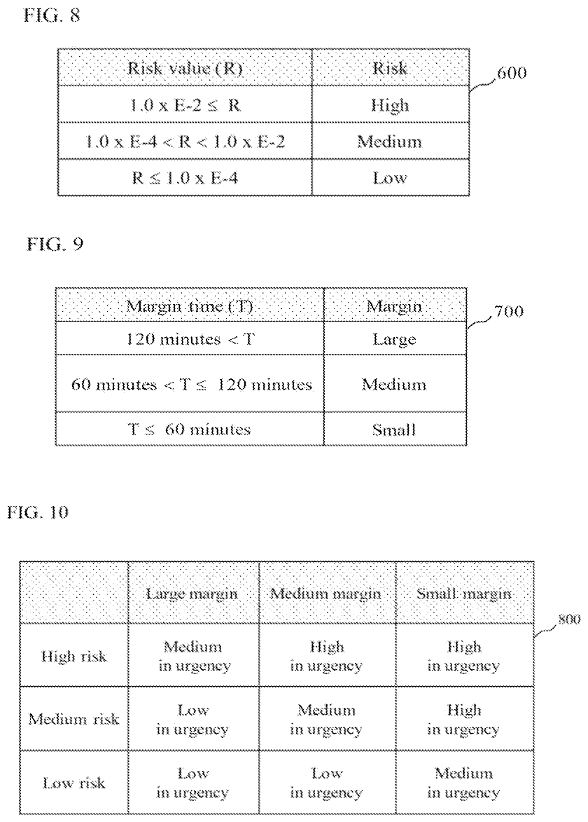

FIG. 8 shows the relationship between a risk value and the risk according to the present embodiment, FIG. 9 shows the relationship between the margin time and the margin according to the present embodiment, and FIG. 10 shows the relationship between the risk, the margin, and the urgency according to the present embodiment. These relationship tables are stored in the evaluation information storage unit 123.

From FIG. 8, FIG. 9, and FIG. 10, Event A in Plant 2 is “high” in the urgency from “high” risk and “medium” margin, Event B in Plant 3 is “medium” in the urgency from “medium” risk and “medium” margin, and Event C in Plant 4 is “low” in the urgency from “low” risk and “low” margin. Therefore, the handling priority is determined as Plant 2>Plant 4 3>Plant 4.

In actual plants, the risk or margin time of an event may vary depending on the plants due to differences in system configuration, etc., but in this example, the risk and margin time of an event (plant information) are the same in each plant.

Next, the scheduling unit 106 performs scheduling of work procedures according to the handling priority of each plant outputted by the handling priority determination unit 105, and outputs some candidates of a work procedure schedule (refer to step S103 in FIG. 3). In the present embodiment, since the plant with high urgency needs to be handled as soon as possible, the scheduling is performed such that operators currently operating (Operator A and Operator B in the present embodiment) can make the response for the handling as much as possible.

First, Procedure 1 (Procedure 1-1 through Procedure 1-4), which is the work procedure for Plant 2 being “high” in the urgency with the highest priority, is assigned. As shown in the work information in FIG. 6, the required qualification for implementing Procedure 1 is Qualification A, and thus Procedure 1 is assigned to Operator A who has Qualification A out of Operator A and Operator B.

Next, Procedure 3 (since Procedure 3-1 and Procedure 3-2 were completed as of 11:00 on Dec. 8, 2020, in this case, Procedure 3-3 through Procedure 3-5 are applicable), which is the work procedure for Plant 4 being “medium” in the urgency with the high priority, is assigned. Procedure 3 is assigned to Operator B because the remaining operator, Operator B, has the necessary qualification B for Procedure 3.

Lastly, Procedure 2 (Procedure 2-2 through Procedure 2-3 (since Procedure 2-1 was completed as of 11:00 on Dec. 8, 2020, in this case, Procedure 2-1 is not applicable.)), which is the work procedure for Plant 3 being “low” in the urgency with the lowest priority, is assigned. As shown in the work information 400 in FIG. 6, the required qualification for implementing Procedure 2 is Qualification B. Of the operators available for the work, four operators with Qualification B are Operator A, Operator B, Operator C, and Operator E (note that Operator G has qualification B but is “on leave”, and not available for the work). Each operator is assigned to the procedures so as to perform the work in the shortest possible time, and four schedules are outputted.

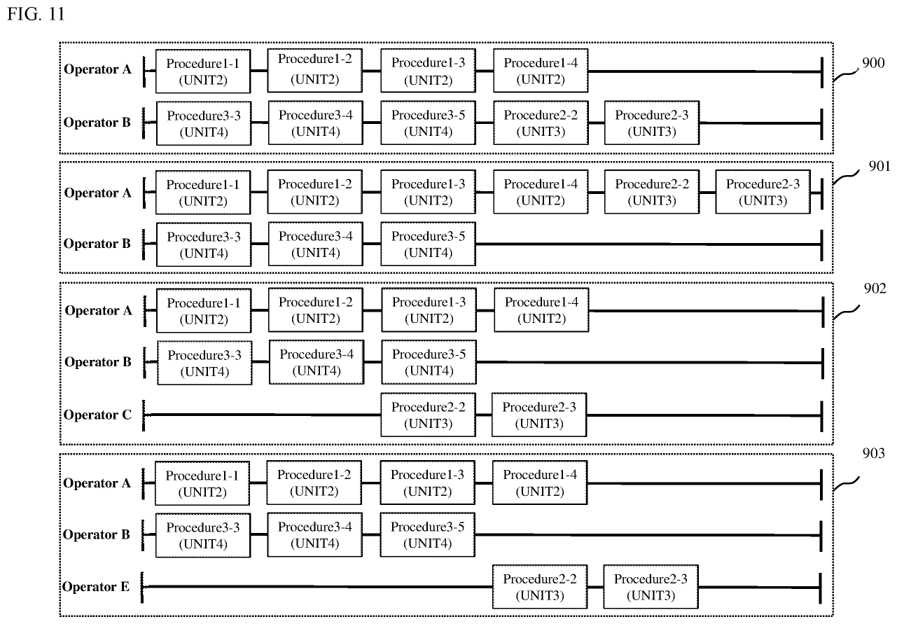

FIG. 11 shows a total of four schedules, Schedule A900, Schedule B901, Schedule C902, and Schedule D903, which are an output of the scheduling unit according to the present embodiment. One box indicating a piece of work corresponds to 30 minutes. Operator C and Operator E are shown with additional 60 and 90 minutes needed for a preparation time including travelling.

Next, the operator state identification unit 107 identifies the current operator state on the basis of the operator information or the work information (refer to step S104 in FIG. 3). In the present embodiment, the operator state is identified on the basis of the operator information such as a fatigue level of an operator or a workload thereof.

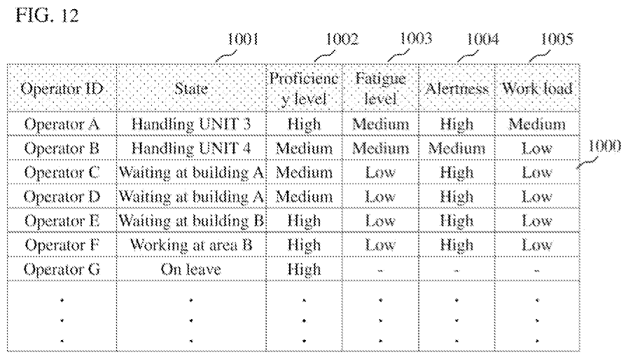

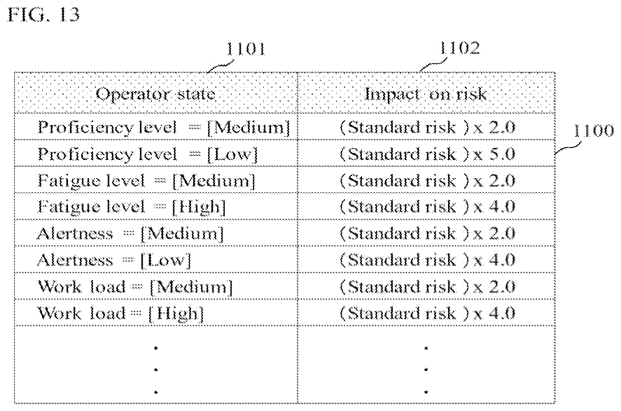

FIG. 12 shows an example of operator states identified by the operator state identification unit according to the present embodiment. An operator state 1000 includes a status 1001, a proficiency level 1002, a fatigue level 1003, alertness 1004, and a workload 1005 for each operator. The fatigue level, the alertness, and the workload are measured, for example, from biometric information such as blood pressure, a heart rate, a respiratory rate, blinking, and brain waves.

Next, the schedule evaluation unit 108 evaluates schedules outputted by the scheduling unit on the basis of the current operator states outputted by the operator state identification unit (refer to step S105 in FIG. 3). In the present embodiment, schedule evaluation is performed on the risk and the handling time (handling time means the time required for an operator to settle an event).

On the basis of Schedule A through Schedule D outputted by the scheduling unit, an impact on the risk in accordance with the operator states is evaluated. FIG. 13 shows a relationship between the operator state and the impact on the risk according to the present embodiment. This relationship table 1100 is stored in the evaluation information storage unit 123. A standard risk is corrected according to an impact-on-risk 1102 in accordance with an operator state 1101.

Operator A, who is the operator of Plant 2, has the proficiency level being “High,” the fatigue level being “Medium,” the alertness being “High,” and the workload being “Medium,” from the operator state in FIG. 12, and thus a value of the risk for Plant 2 is 1.2×E-1 (=3.0×E-2×2.0×2.0). Operator B, who is the operator of Plant 4, has the proficiency level being “Medium,” the fatigue level being “Medium,” the alertness being “Medium,” and the workload being “Low” from the operator state in FIG. 12, and thus a value of the risk for Plant 4 is 1.6×E-4 (=2.0×E-5×2.0×2.0×2.0).

Since a corresponding operator or procedure for each schedule differs, a value of the risk for Plant 3 is calculated for each of the cases from Schedule A to Schedule D. Operator B, who is the operator of Plant 3 in Schedule A, has the proficiency level being “Medium,” the fatigue Level being “Medium,” the alertness being “Medium,” and the workload being “Low” from the operator state 1000 in FIG. 12, and thus a value of the risk for Plant 3 can be calculated to be 1.6×E-3 (=2.0×E-4×2.0×2.0×2.0).

Similarly, Operator A, who is the operator in Schedule B, has the proficiency level being “High,” the fatigue level being “Medium,” the alertness being “High,” and the workload being “Medium,” and thus a value of the risk for Plant 3 is 8.0×E-4 (=2.0×E-4×2.0×2.0). Operator C, who is the operator in Schedule C has the proficiency level being “Medium,” the fatigue level being “Low,” the alertness being “High,” and the workload being “Low,” and thus a value of the risk for Plant 3 is 4.0×E-4 (=2.0×E-4×2.0), and Operator E, who is the operator in Schedule D, has the proficiency level being “High,” the fatigue level being “Low,” the alertness being “High,” and the workload being “Low,” and thus a value of the risk for Plant 3 is 2.0×E-4.

In the present embodiment, the total sum of the values of the risk for Plant 2, Plant 3, and Plant 4, which are at risk, is used as the risk of each schedule. Here, since Plant 2 and Plant 4 are commonly present in each schedule (refer to FIG. 11), the evaluation ranking on the risk of the schedules is to be determined by the value of the risk for Plant 3. From the above explanation, the value of the risk for Schedule A is 1.6×E-3, the value of the risk for Schedule B is 8.0×E-4, the value of the risk for Schedule C is 4.0×E-4, and the value of the risk for Schedule D is 2.0×E-4. Thus, the evaluation ranking on the risk of the schedules is Schedule D>Schedule C>Schedule B>Schedule A.

Next, for Schedule A through Schedule D outputted by the scheduling unit, an evaluation of the impact on the handling time in accordance with the operator states is performed. As for the handling time, since FIG. 11 shows the additional 60 and 90 minutes required for the preparation time including travelling, the time when entire work is completed is directly evaluated as the handling time. Therefore, the evaluation ranking on the handling time in the schedules is Schedule C>Schedule A and Schedule D>Schedule B.

The schedule presentation unit 109 presents the schedules to an output device such as a monitor on the basis of the evaluation results of the schedule evaluation unit (refer to step S106 in FIG. 3).

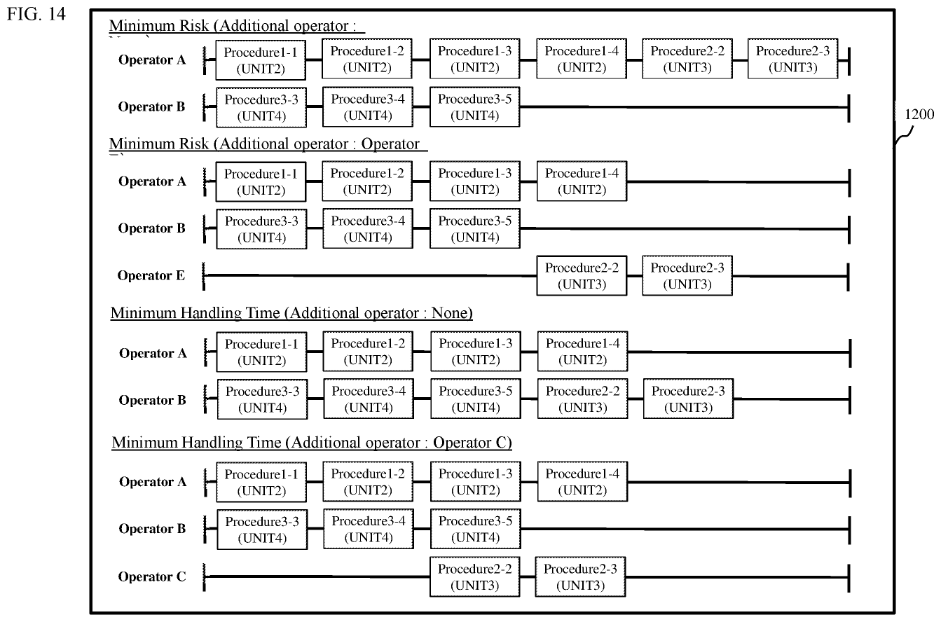

FIG. 14 shows a presentation example 1200 of the schedule presentation unit according to the present embodiment. As schedules that can be recommended, the schedules are displayed according to four following conditions: Schedule B with no additional operator and the lowest value of the risk, Schedule D with an additional operator and the lowest value of the risk, Schedule A with no additional operator and the shortest handling time, and Schedule C with an additional operator and the shortest handling time. Note that implementation may be modified such that the presentation displayed with the ranking in the evaluated risk or the handling time, or with the presence or absence of an additional operator can be switched.

Next, the operator addition necessity determination unit 110 determines the necessity of operator addition according to an operator excess/deficiency determination rule on the basis of the evaluation results of the schedule evaluation unit (refer to step S107 in FIG. 3).

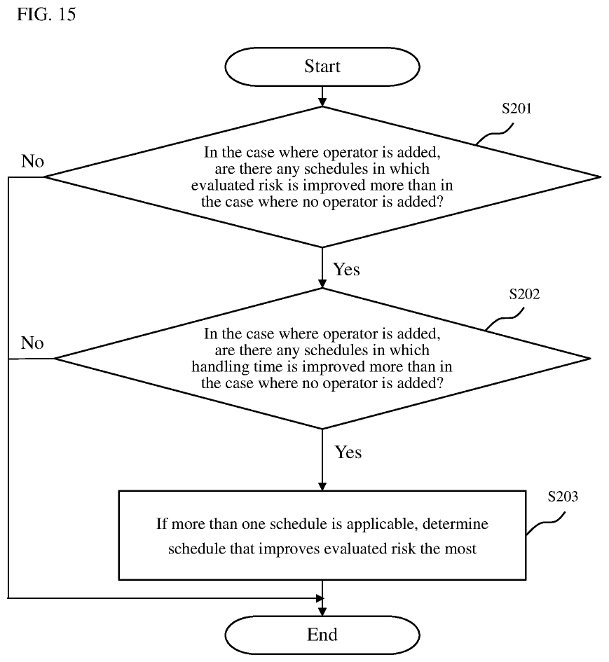

FIG. 15 is a flowchart showing an example of an addition necessity determination according to the present embodiment. The addition necessity determination rule used for the addition necessity determination is stored in the addition necessity determination rule storage unit 124.

In the flowchart showing an example of the addition necessity determination described above, and in the first processing step, step S201: “In the case where an operator is added, are there any schedules in which the evaluated risk is improved more than in the case where no operator is added?,” since Schedule C and Schedule D with the additional operators are improved in the evaluated risk more than Schedule A and Schedule B with no additional operator, Schedule C and Schedule D are both applicable.

Next, in the second processing step, step S202: “In the case where an operator is added, are there any schedules in which the handling time is improved more than in the case where no operator is added?,” Schedule C is improved in the handling time more than Schedule A and Schedule B, but Schedule D is not improved in the handling time as compared with Schedule A, and thus only Schedule C is applicable.

Lastly, in the final processing step, step S203: “If more than one schedule is applicable, determine the schedule that improves the evaluated risk the most,” since the only applicable schedule is Schedule C, it is determined that the addition of Operator C is necessary.

The operator calling unit 111 calls the operator according to the determination result of the operator addition necessity determination unit (refer to step S108 in FIG. 3). In the present embodiment, an alarm is notified to a tablet terminal owned by the additional operator, Operator C, and the operator is called.

In the present embodiment, the plant status identification unit and the operator state identification unit identify the current plant status or the operator states, but it is also possible to identify and determine the future status by predicting the future using, for example, a simulator.

In the present embodiment, the evaluation targets are the risk and the handling time, but costs and other factors may also be evaluated. Further, those evaluation values may be evaluated comprehensively. For example, a method in which each factor is quantified and the determination is made by the summed numerical value or a method in which each factor is weighted and the summed value is calculated, can be considered. Furthermore, a method in which the weighting is changed dynamically is also possible.

In the present embodiment, for the sake of simplicity, it is assumed that the time required for each procedure is the same and the description is made as a pattern in which the next procedure is started immediately after the completion of the previous procedure, but this is not a limitation. It is also possible to cope with a complex procedure in which a different time for each procedure is set or another procedure before the end of one procedure is started, for example.

According to the plant operation assistance system of Embodiment 1, the handling priority of an unit (each plant) is determined on the basis of the plant status, scheduling is performed on the basis of the handling priority of the unit (each plant), and the schedules are evaluated on the basis of the plant status or the operator states.

This enables dynamic work assignment to each operator to minimize the impact on the entire plants (risk, handling time, etc.), thereby reducing the risk of plant operation, improving work efficiency, and reducing costs.

Furthermore, according to the plant operation assistance system of Embodiment 1, the necessity of operator addition is determined, and if an additional operator is required, the most appropriate operator is identified and called, thereby enabling further risk reduction in the plant operation.

### Embodiment 2

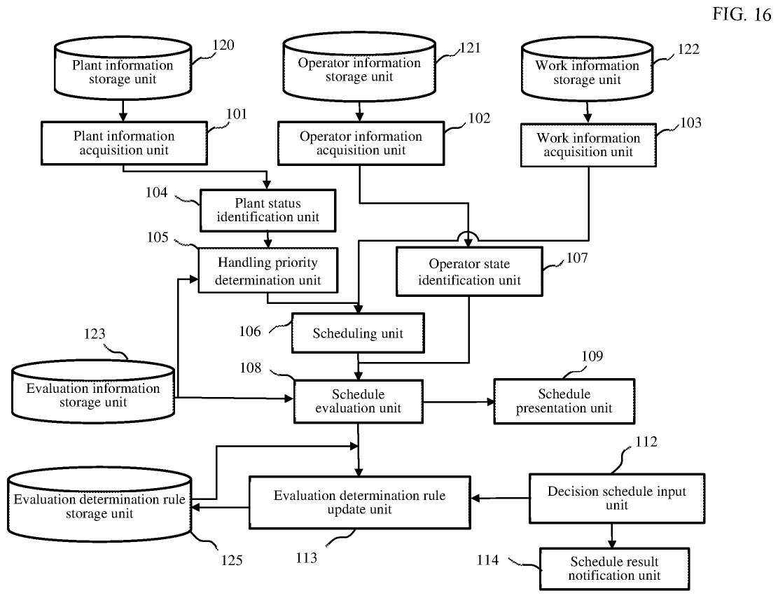

A hardware configuration diagram according to Embodiment 2 is the same as that of Embodiment 1. FIG. 16 is a functional block diagram of a plant operation assistance system according to Embodiment 2. An evaluation determination rule storage unit 125, a decision schedule input unit 112, an evaluation determination rule update unit 113, and a schedule result notification unit 114 are added in the functional blocks in Embodiment 1.

In the following description, the plant operation assistance system according to Embodiment 2 will be described using FIG. 16 through FIG. 19, focusing on components that differ from those in Embodiment 1. Note that the steps are the same as those in Embodiment 1 up to the operator state identification unit 107 that identifies the operation status.

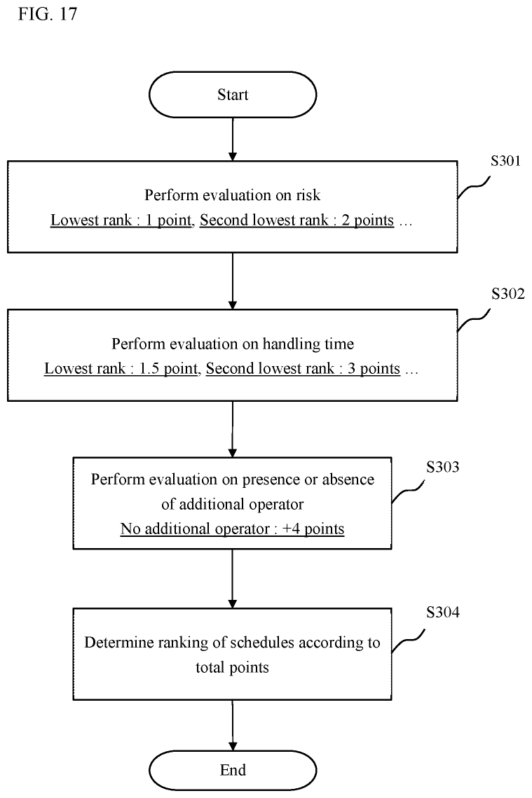

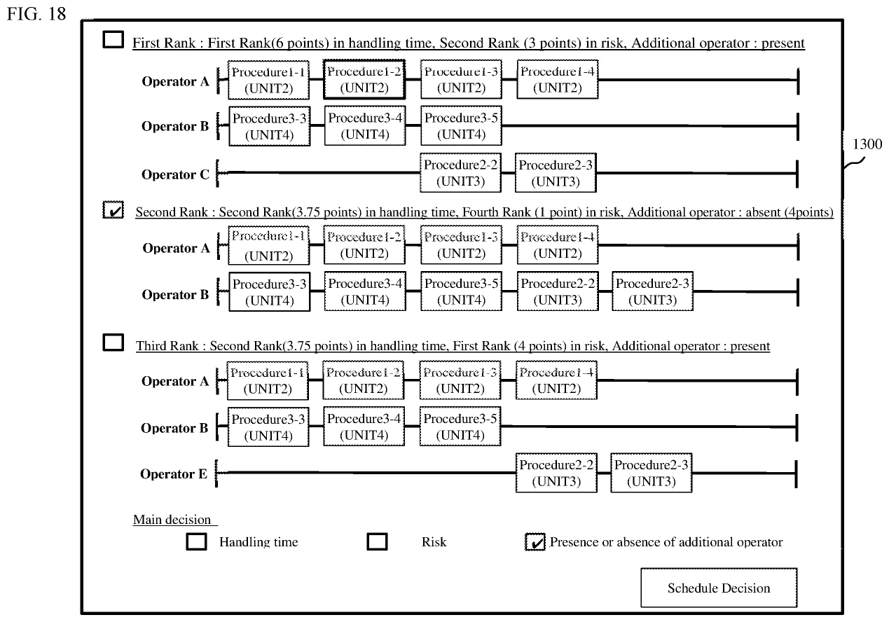

Evaluation determination rules for evaluating schedules are stored in the evaluation determination rule storage unit 125. FIG. 17 shows an example of a flowchart to be used for evaluation and determination of the schedules. The evaluation determination rule data stored in the evaluation determination rule storage unit is used for the evaluation and determination here. In Embodiment 2, the schedule evaluation unit 108 evaluates the schedules and determines the ranking of the schedules according to the evaluation determination rules in FIG. 17.

First, in step S301, which is a processing step of the evaluation and determination, evaluation on the risk is performed. According to the evaluation result on the risk that is the same as in Embodiment 1: “Schedule D>Schedule C>Schedule B>Schedule A,” Schedule A gets “1 point,” Schedule B gets “2 points,” Schedule C gets “3 points,” and Schedule D gets “4 points.”

Next, in step S302, which is a processing step of the evaluation and determination, evaluation on the handling time is performed. According to the evaluation result that is the same as in Embodiment 1: “Schedule C>Schedule A and Schedule D>Schedule B”, Schedule A gets “3.75 points,” Schedule B gets “1.5 points,” Schedule C gets “6 points,” and Schedule D gets “3.75 points.” Since Schedule A and Schedule D are tied in terms of the handling time and are second from the bottom, “3.75 points” is used, which is the average of the second lowest “3 points” and the third lowest “4.5 points.”

Next, in step S303, which is a processing step of the evaluation and determination, evaluation on the presence or absence of an additional operator is performed. Schedule A and Schedule B with no additional operator get “+4 points.” Lastly, in step S304, which is a processing step of the evaluation and determination, the scores evaluated so far are added to calculate the total points, and the ranking of schedules is determined according to the total points. The ranking of schedules is “Schedule C (3+6=9 points)>Schedule A (1+3.75+4=8.75 points)>Schedule D (4+3.75=7.75 points)>Schedule B (2+1.5+4=7.5 points).”

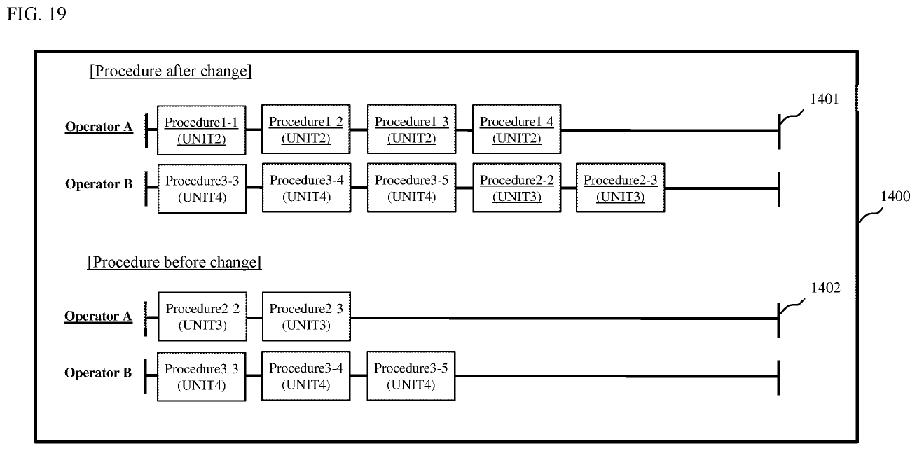

The schedule presentation unit 109 presents the schedules to an output device such as a monitor on the basis of the evaluation results of the schedule evaluation unit. FIG. 18 is a presentation example 1300 of the schedule presentation unit according to Embodiment 2. “Schedule C,” “Schedule A,” and “Schedule D” up to the top three ranking are displayed according to the evaluation ranking evaluated by the schedule evaluation unit 108. Along with the evaluation ranking, the ranking and evaluation points on the handling time, the ranking and evaluation points on the risk, and the presence or absence of an additional operator and evaluation points are also displayed together.

The decision schedule input unit 112 inputs a decision on the schedule by a user. In Embodiment 2, the decision schedule input unit displays the schedules and the decision reasons such that they can be selected by check boxes, as shown in the presentation example of the schedules in FIG. 18, and the user selects them by the input on the check boxes. Assuming that the user, namely, a leader of the operators in the present embodiment, has selected the second-ranked “Schedule A” and the main decision reason of “presence or absence of additional operator” using the check boxes, the following explanation will be given.

The evaluation determination rule update unit 113 updates the evaluation determination rules according to the inputted contents of the decision schedule input unit 112. In the present embodiment, the processing step S303 in terms of “presence or absence of additional operator” is modified according to the selected main decision reason “presence or absence of additional operator” so that Schedule A exceeds Schedule C in the total points. Specifically, “Evaluation on the presence or absence of an additional operator is performed. No additional operator: +4 points“is updated to” Evaluation on the presence or absence of an additional operator is performed. No additional operator: +4.5 points.” Thereafter, the schedule evaluation unit 108 evaluates the schedules according to the updated evaluation determination rules.

The schedule result notification unit 114 notifies each operator of the result of the schedules according to the inputted contents of the decision schedule input unit 112. In the present embodiment, an alarm is notified to a tablet terminal owned by each operator.

FIG. 19 shows a result-notification example 1400 of the schedule result notification unit according to Embodiment 2. The result-notification example 1400 notifies Operator A of a change in the operation procedure. It indicates that a procedure 1402 before the change has been changed to a procedure 1401 after the change. Parts where the procedures have been changed are shown in red.

Note that, although the method of updating the evaluation determination rules using a simple method is described in the present embodiment, it is not limited to this method and artificial intelligence such as machine learning including deep learning may be used.

According to the plant operation assistance system of Embodiment 2, by updating the evaluation determination rules and feeding back the result of the decided schedules, the accuracy in the schedule evaluation can be improved as the number of times the system is used increases. Furthermore, according to the plant operation assistance system of Embodiment 2, the result of the decided schedule can be notified to each operator to further reduce the risk of the plant operation.

Note that, although various exemplary embodiments and examples are described in the present application, various features, aspects, and functions described in one or more embodiments are not inherent in a particular embodiment and can be applicable alone or in their various combinations to each embodiment. Accordingly, countless variations that are not illustrated are envisaged within the scope of the art disclosed herein.

For example, the case where at least one component is modified, added or omitted, and the case where at least one component is extracted and combined with a component in another embodiment are included.

### DESCRIPTION OF REFERENCE NUMERALS AND SIGNS

1: processor, 2: memory, 3: hard disk, 4: input device, 5: output device, 6: system bus, 101: plant information acquisition unit, 102: operator information acquisition unit, 103: work information acquisition unit, 104: plant status identification unit, 105: handling priority determination unit, 106: scheduling unit, 107: operator state identification unit, 108: schedule evaluation unit, 109: schedule presentation unit, 110: operator addition necessity determination unit, 111: operator calling unit, 112: decision schedule input unit, 113: evaluation determination rule update unit, 114: schedule result notification unit, 120: plant information storage unit, 121: operator information storage unit, 122: work information storage unit, 123: evaluation information storage unit, 124: addition necessity determination rule storage unit, 125: evaluation determination rule storage unit

1. A plant operation assistance system comprising:
a plant information acquisition circuitry to acquire information on a plant including an impact degree of an event, an event probability, a handling time for the event, and varying information including an operation history of the plant;
an operator information acquisition circuitry to acquire operator information including information on an owned qualification, a proficiency level, and a work status for operators of the plant;
a work information acquisition circuitry to acquire work information of the plant including work contents, a work procedure, and a work difficulty level;
a plant status identification circuitry to identify an event occurring at the plant from information acquired by the plant information acquisition circuitry;
a handling priority determination circuitry to determine, for a plurality of plants, handling priority for determining an operation procedure for each plant when an event occurs;
a scheduling circuitry to schedule a work procedure for each plant on a basis of the determined handling priority for the plants and to output a plurality of work procedure schedules;
an operator state identification circuitry to identify an operator state including a work status and a physical state for each operator from the operator information and the work information;
a schedule evaluation circuitry to set a plurality of parameters affecting operation of a plant integrated circuitry integrating the plurality of plants, on a basis of the operator state outputted by the operator state identification circuitry,
to calculate an impact on the operation of the plant integrated circuitry using the plurality of parameters, and
to evaluate the work procedure schedules outputted by the scheduling circuitry on a basis of the impact; and
a schedule presentation circuitry to present an evaluation result of the schedules evaluated by the schedule evaluation circuitry to an output device.

2. The plant operation assistance system according to claim 1, wherein the evaluation result of the schedules is presented by sectioning a display position in accordance with variables and values of the parameters when an event occurs.

3. The plant operation assistance system according to claim 1, further comprising:
an addition necessity determination rule storage circuitry to store an addition necessity determination rule of an operator of the plants;
an operator addition necessity determination circuitry to determine necessity of operator addition according to the addition necessity determination rule; and
an operator calling circuitry to call a necessary operator according-to an output of the operator addition necessity determination circuitry.

4. The plant operation assistance system according to claim 1, further comprising:
an evaluation determination rule storage circuitry to store an evaluation determination rule for a schedule of the work procedure for each plant;
a decision schedule input circuitry to input a schedule determined by a user; and
an evaluation determination rule update circuitry to update the evaluation determination rule according to inputted contents of the decision schedule input circuitry.

5. The plant operation assistance system according to claim 1, further comprising:
the decision schedule input circuitry to input the schedules determined by the user; and
a schedule result notification circuitry to notify each operator of the result of the schedule according to the inputted contents of the decision schedule input circuitry.

6. The plant operation assistance system according to claim 2, further comprising:
an addition necessity determination rule storage circuitry to store an addition necessity determination rule of an operator of the plants;
an operator addition necessity determination circuitry to determine necessity of operator addition according to the addition necessity determination rule; and
an operator calling circuitry to call a necessary operator according-to an output of the operator addition necessity determination circuitry.

7. The plant operation assistance system according to claim 2, further comprising:
an evaluation determination rule storage circuitry to store an evaluation determination rule for a schedule of the work procedure for each plant;
a decision schedule input circuitry to input a schedule determined by a user; and
an evaluation determination rule update circuitry to update the evaluation determination rule according to inputted contents of the decision schedule input circuitry.

8. The plant operation assistance system according to claim 2, further comprising:
the decision schedule input circuitry to input the schedules determined by the user; and
a schedule result notification circuitry to notify each operator of the result of the schedule according to the inputted contents of the decision schedule input circuitry.

9. The plant operation assistance system according to claim 3, further comprising:
the decision schedule input circuitry to input the schedules determined by the user; and
a schedule result notification circuitry to notify each operator of the result of the schedule according to the inputted contents of the decision schedule input circuitry.

10. The plant operation assistance system according to claim 4, further comprising:
the decision schedule input circuitry to input the schedules determined by the user; and
a schedule result notification circuitry to notify each operator of the result of the schedule according to the inputted contents of the decision schedule input circuitry.

11. The plant operation assistance system according to claim 6, further comprising:
the decision schedule input circuitry to input the schedules determined by the user; and
a schedule result notification circuitry to notify each operator of the result of the schedule according to the inputted contents of the decision schedule input circuitry.

12. The plant operation assistance system according to claim 7, further comprising:
the decision schedule input circuitry to input the schedules determined by the user; and
a schedule result notification circuitry to notify each operator of the result of the schedule according to the inputted contents of the decision schedule input circuitry.
